(19) United States
(12) Patent Application Publication
(10) Pub. No.: US 2009/0227737 A1
(43) Pub. Date: Sep. 10, 2009

(54) Vibration Absorber Composition

(75) Inventors: Katsuo Okamoto, Chino-shi (JP); Ryoichiro Yamada, Chino-shi (JP); Takashi Yazaki, Chino-shi (JP); Yuichi Nakamura, Chino-shi (JP)

Correspondence Address: BIRCH STEWART KOLASCH & BIRCH, PO BOX 747, FALLS CHURCH, VA, 22040-0747, US

(73) Assignee: MIYASAKA GOMU KABUSHIKI KAISHA, Chino-shi (JP)

(21) Appl. No.: 11/991,605

(22) PCT Filed: Sep. 7, 2005
(86) PCT No.: PCT/JP2005/016426

§ 371 Date: Mar. 7, 2008

(51) Int. Cl. C08L 53/02

(52) U.S. Cl. 525/98

(57) ABSTRACT

An object of the present invention is to provide a vibration absorber composition, which has excellent vibration-damping properties in an atmosphere having a temperature not lower than the room temperature, has excellent elasticity, and can be molded by compression molding. The vibration absorber composition is composed of a compression-moldable elastomer obtained by mixing 100 parts by weight of an isobutylene-isoprene copolymer (IIR) with 10-70 parts by weight of a block copolymer, which comprises a block of a styrene monomer and a vinyl-polyisoprene block and which has a main dispersion peak of tan δ at −40° C. or higher, and crosslinking the mixture; when the rubber elastomer has a peak temperature for the main dispersion X of tan δ at 100 Hz from 0 to +60° C., a peak value is 0.4 or greater, and the value of tan δ of the rubber elastomer is greater than the value of tan δ at 100 Hz of the IIR for the main dispersion Y of tan δ thereof at 100 Hz in a temperature region not lower than the peak temperature.

### FIELD OF TECHNOLOGY

The present invention relates to a vibration absorber composition, more precisely relates to a vibration absorber composition whose main component is a rubber composition.

### BACKGROUND TECHNOLOGY

A composition for absorbing vibration is disclosed in Japanese Patent No. 2703288. The main component of the composition is a block copolymer, whose molecular weight is 40000-300000 and which comprises: a block, whose each molecule includes two or more vinyl aromatic monomers, e.g., styrene monomers, having number average molecular weight of 3000-40000; and one or a plurality of block composed of isoprene or isoprene-butadiene, whose vinyl-binding content is 40% or more and whose main dispersion peak of tan δ is −40° C. or higher.

A blended vibration absorber composition may be obtained by mixing 20 or less parts by weight of a rubber composition with 100 parts by weight of said block copolymer.

### DISCLOSURE OF THE INVENTION

In the block copolymer comprising the polystyrene block and the vinyl-polyisoprene block, which is disclosed in said patent, the polystyrene block and the vinyl-polyisoprene block are bound together and formed into a web formation as shown in FIG. 5.

As to the block copolymer, a measured relationship between tan δ (loss tangent) and temperature is shown in FIG. 6. In FIG. 6, the horizontal axis is temperature; the vertical axis is a logarithmic scale of the value of tan δ. In FIG. 6, main dispersion of tan δ of the block copolymer comprising the polystyrene block and isoprene/butadiene block is A; main dispersion of tan δ of the block copolymer comprising the polystyrene block and the isoprene block is B. Peak values of the main dispersion of tan δ of the both block copolymers are greater than 1.

Further, in the block copolymers shown in FIG. 6, the value of tan δ in the temperature range higher than the peak temperature of the main dispersion of tan δ is higher than that in the temperature range lower than the peak temperature. Therefore, molded bodies composed of the block copolymers have excellent vibration-damping properties at the temperature higher than the peak temperatures of tan δ.

However, the block copolymers shown in FIG. 6 are thermoplastic polymers, so they must be heated until reaching melting points for molding. Therefore, it is very difficult to mold the block copolymers by a compression molding method, which has been employed to mold an ordinary rubber composition.

Further, hardness of the molded bodies of the block copolymers are very high, e.g., 90, so packing members composed of the block copolymers cannot seal sufficiently.

The block copolymers have insufficient moldabilities, the molded bodies have insufficient elastic properties, and blended compositions of the block copolymers have insufficient properties as well.

On the other hand, ordinary rubber compositions, e.g., isobutylene-isoprene copolymer (IIR), ethylene-propylene copolymer (EPDM), can be easily compression-molded.

However, a value of tan δ of a molded packing, which is composed of an ordinary rubber composition only, at the room temperature or higher (e.g., tan δ of IIR at 100 Hz of 25° C. is 0.20; tan δ of EPDM at 100 Hz of 25° C. is 0.13) is very smaller than the values of tan δ of the block copolymers shown in FIG. 6. Therefore, the vibration-damping properties of the molded body, which is composed of the ordinary rubber composition only, in a high temperature atmosphere, whose temperature is higher than the room temperature, are insufficient. These days, a molded body, which has sufficient vibration-damping properties in a car heated by summer sunshine, is required.

An object of the present invention is to provide a vibration absorber composition, which has excellent vibration-damping properties in an atmosphere having a temperature not lower than the room temperature, has excellent elasticity, and can be molded by compression molding.

The inventors of the present invention have studied to achieve the object, and they found that a rubber elastomer, which was obtained by mixing the block copolymer having the main dispersion A or B of tan δ shown in FIG. 6 with an isobutylene-isoprene copolymer (IIR) or an ethylene-propylene copolymer (EPDM) and crosslinking the mixture, could be molded by the ordinary compression-molding method, and that the rubber elastomer had excellent vibration-damping properties in a high temperature region higher than the peak temperature of the main dispersion of tan δ, so that they reached the present invention.

Namely, the vibration absorber composition of the present invention is composed of a compression-moldable elastomer obtained by mixing 100 parts by weight of a rubber composition with 10-70 parts by weight of a block copolymer, which comprises a block of a styrene monomer and a vinyl-polyisoprene block and which has a main dispersion peak of tan δ at −40° C. or higher, and crosslinking the mixture, and is characterized in that the rubber elastomer has a peak temperature for the main dispersion of tan δ at 100 Hz from −20 to +60° C., a peak value is 0.4 or greater, and that the value of tan δ of the rubber elastomer is greater than the value of tan δ at 100 Hz of the rubber composition for the main dispersion of tan δ thereof at 100 Hz in a temperature region not lower than the peak temperature.

Preferably, content of styrene in the block copolymer is 10-30%, and a glass-transition temperature thereof is −40 to +30° C.; and the value of tan δ of the rubber elastomer at 100 Hz of 25° C. is 0.3 or greater.

Preferably, hardness of the rubber elastomer measured by a type A durometer is 5-80 (more preferably 10-60).

When the peak temperature of the rubber elastomer for the main dispersion of tan δ at 100 Hz is from 0 to +60° C., the rubber elastomer has excellent elastic properties in the high temperature region. For example, the rubber composition is an isobutylene-isoprene copolymer (IIR).

In case that the values of tan δ at temperatures of ±10° C. with respect to the peak temperature of the main dispersion of tan δ of the rubber elastomer at 100 Hz are (said peak value−0.2) or greater, reduction rates of tan δ of the rubber elastomer in the high temperature region, in which the temperature is higher than the peak temperature, and the lower temperature region, in which the temperature is lower than the peak temperature, are lower than those of the rubber elastomer composed of the IIR. Therefore, a vibration-damping range can be extended. For example, the rubber composition is ethylene-propylene copolymer (EPDM).

In comparison with the main dispersion of tan δ of the rubber composition, the value of tan δ of the vibration absorber composition of the present invention is greater at the temperature not lower than the room temperature. Therefore, in comparison with a molded body composed of the rubber composition, the vibration-damping properties of a molded body composed of the vibration absorber composition of the present invention can be improved at the temperature not lower than the room temperature.

Since the main component of the vibration absorber composition of the present invention is the rubber composition, the vibration absorber composition can be compression-molded, the molded body has excellent elasticity and a packing member composed of the vibration absorber composition can have a sufficient sealing property.

### BRIEF DESCRIPTION OF THE DRAWINGS

FIG. 1 is a graph showing examples of main dispersion of tan δ of the vibration absorber compositions of the present invention.

FIG. 2 is an explanation view of equipment for measuring vibration-damping properties of a sheet member composed of the vibration absorber composition.

FIG. 3 is a graph showing other examples of main dispersion of tan δ of the vibration absorber compositions of the present invention.

FIG. 4 is a graph showing examples of main dispersion of tan δ with respect to hardness of the vibration absorber compositions of the present invention.

FIG. 5 is an explanation view of an inner structure of a block copolymer, which is used for producing the vibration absorber composition of the present invention.

FIG. 6 is a graph showing example of main dispersion of tan δ of the block copolymers, which are used for producing the vibration absorber compositions of the present invention.

### OPTIMUM EMBODIMENTS OF THE INVENTION

In the present invention, a rubber elastomer obtained by mixing 100 parts by weight of a rubber composition with 10-70 parts by weight of a block copolymer, which comprises a block of a styrene monomer and a vinyl-polyisoprene block and which has a main dispersion peak of tan δ at −40° C. or higher (preferably from −32 to +20° C.), and crosslinking the mixture is used.

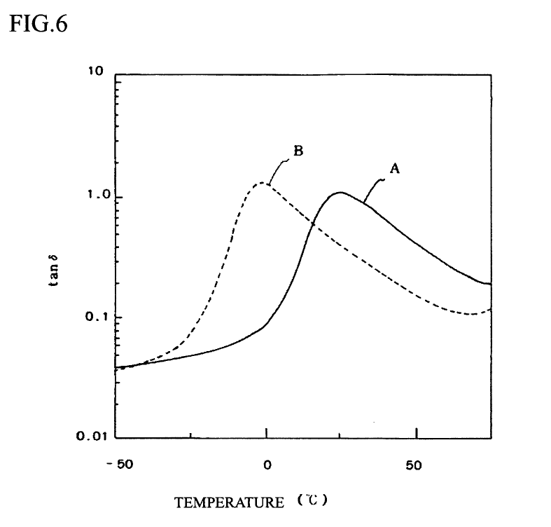

The block copolymer can be produced by the method disclosed in the above described patent gazette, and it has the main dispersion of tan δ shown in FIG. 6.

Preferably, content of styrene in the block copolymer is 10-30%, and a glass-transition temperature thereof is from −40 to +30° C. If the content of styrene is less than 10%, the block copolymer clumps, so it is difficult to treat the copolymer; if the content of styrene is more than 30%, the glass-transition temperature is higher than 30° C., so the obtained composition does not have sufficient elasticity at the room temperature.

Ordinary rubber compositions, e.g., isobutylene-isoprene copolymer (IIR), ethylene-propylene copolymer (EPDM), natural rubber (NR), styrene butadiene rubber (SBR), chloroprene rubber (CR), acrylonitrile butadiene rubber (NBR), chlorosulfonated polyethylene rubber (CSM), acrylic rubber (ACM), fluorocarbon rubber (FKM), which can be compression-molded, may be used, especially isobutylene-isoprene copolymer (IIR) and ethylene-propylene copolymer (EPDM) are preferable.

Further, the block copolymer and the rubber composition are crosslinked by the steps of: kneading the both with a crosslinking agent by a kneader; and then performing a heat treatment at a prescribed temperature. Known crosslinking agents used for producing rubber compositions, e.g., peroxide, sulfur, may be used as the crosslinking agent, and the heat treatment may be performed while compression-molding the product.

In the present invention, 100 parts by weight of the rubber composition and 10-70 parts by weight of the block copolymer are mixed when they are crosslinked.

100 parts by weight of the rubber composition, i.e., isobutylene-isoprene copolymer (IIR), and 10-70 parts by weight of the block copolymer, which included 20% of styrene and whose glass-transition temperature thereof was −17° C., were kneaded and crosslinked so as to produce a rubber elastomer, and measured values of tan δ of 25° C. at 100 Hz are shown in TABLE 1.

TABLE 1

| | BLOCK COPOLYMER (PARTS BY WEIGHT) | | | | | |
|---|---|---|---|---|---|---|
| | 5 | 10 | 20 | 50 | 70 | 80 |
| tan δ | 0.23 | 0.55 | 0.78 | 1.02 | 1.35 | 1.34 |

In the IIR, tan δ of 25° C. at 100 Hz is about 0.2. According to TABLE 1, when the amount of the block copolymer was less than 10 parts by weight, tan δ of the obtained rubber elastomer was small and approximated to that of the IIR, so the rubber elastomer had insufficient vibration-damping properties. On the other hand, when more than 70 parts by weight of the block copolymer was mixed with 100 parts by weight of the IIR, tan δ of the obtained rubber elastomer was small and physical properties thereof were worsened.

100 parts by weight of the rubber composition, i.e., ethylene-propylene copolymer (EPDM), and the block copolymer, which included 20% of styrene and whose glass-transition temperature thereof was −17° C., were kneaded and crosslinked so as to produce a rubber elastomer, and measured values of tan δ of 25° C. at 100 Hz are shown in TABLE 2.

TABLE 2

| | BLOCK COPOLYMER (PARTS BY WEIGHT) | | | | | |
|---|---|---|---|---|---|---|
| | 5 | 10 | 20 | 50 | 70 | 80 |
| tan δ | 0.16 | 0.23 | 0.40 | 0.63 | 0.72 | 0.71 |

According to TABLE 2, when the amount of the block copolymer in the EPDM was less than 10 parts by weight, tan δ of the obtained rubber elastomer was small and approximated to that of the rubber composition, so the rubber elastomer had insufficient vibration-damping properties. On the other hand, when more than 70 parts by weight of the block copolymer was mixed with 100 parts by weight of the EPDM, tan δ of the obtained rubber elastomer was small and physical properties thereof were worsened.

In the rubber elastomer obtained by mixing 10-70 parts by weight of the block copolymer with 100 parts by weight of the rubber composition and crosslinking the mixture, a peak temperature of main dispersion of tan δ at 100 Hz was from −20 to +60° C., a peak value was 0.4 or greater and the value of tan δ of the obtained rubber elastomer was greater than the value of tan δ at 100 Hz of the rubber composition in a temperature region not lower than the peak temperature.

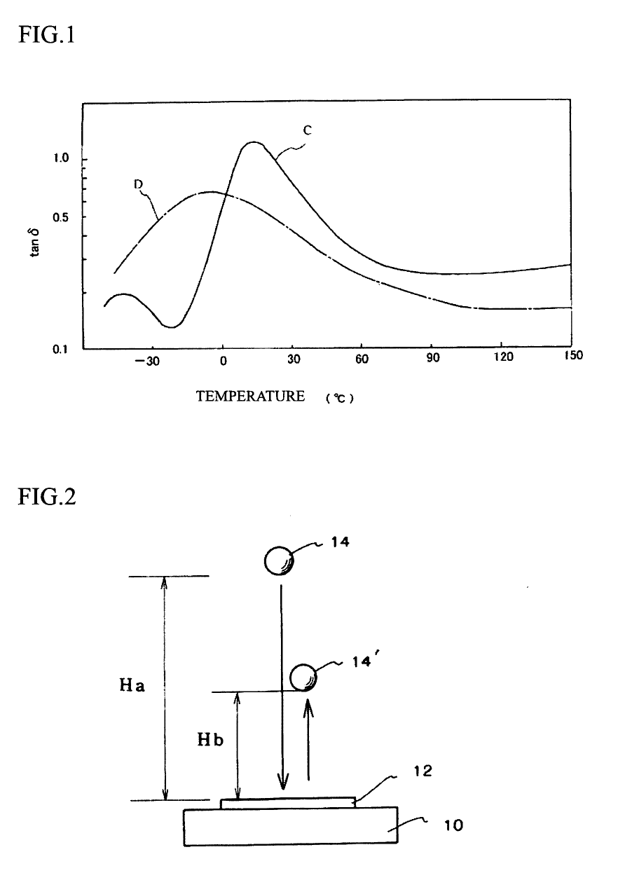

The main dispersion of tan δ of the rubber elastomer is shown in FIG. 1. The rubber elastomer having the main dispersion C of tan δ shown in FIG. 1 was produced by the steps of: kneading 100 part by weight of the IIR, 50-70 parts by weight of the block copolymer, whose main dispersion A of tan δ was shown in FIG. 6, and the crosslinking agent (e.g., peroxide, sulfur) by a kneader; and heating and compression-molding the mixture so as to form into a sheet-shaped member having a thickness of 1 mm.

The sheet-shaped member was composed of the rubber elastomer, and hardness of the sheet-shaped member measured by a type A durometer was 40. The hardness can be controlled by adjusting an amount of an inorganic additive agent, which was added to the mixture in the kneading step, and preferable hardness measured by the type A durometer is 5-80, more preferably 10-80. If the hardness is more than 80, the peak value of the main dispersion of tan δ at 100 Hz is reduced; if the hardness is less than 5, the peak value of the main dispersion of tan δ at 100 Hz appears at a temperature lower than 0° C.

Note that, in FIG. 1, the main dispersion of tan δ of another sheet-shaped member, which was composed of IIR only and whose thickness was 1 mm, is shown as the main dispersion D.

As to the main dispersion C of tan δ shown in FIG. 1, the peak value of the main dispersion of tan δ is 1.24, and the peak appears at a temperature of 20° C. In a temperature region not lower than the peak temperature or 20° C., the value of the main dispersion C of tan δ is greater than that of the main dispersion C of tan δ of the IIR as shown in FIG. 1.

As to the main dispersion C of tan δ shown in FIG. 1, the value of tan δ at 25° C. is 0.3 or more, and the value of tan δ at 60° C. is 0.2 or more. The values of tan δ are greater than those of the main dispersion D of tan δ at 25° C. and 60° C. In comparison with the sheet-shaped member composed on the IIR only, the sheet-shaped member having the main dispersion C of tan δ shown in FIG. 1 has excellent vibration-damping properties in a high temperature atmosphere, in which the temperature is the room temperature or higher.

The vibration-damping properties of the sheet-shaped member having the main dispersion C of tan δ shown in FIG. 1 were measured by equipment shown in FIG. 2. In the equipment shown in FIG. 2, the sheet-shaped member 12 was mounted on a metal block 10, a metal ball 14 (having a diameter of 10 mm and a weight of 5.5 g) was dropped on the sheet-shaped member 12 from a predetermined place, whose height from the upper face of the sheet-shaped member 12 is Ha (500 mm), and a bouncing height Hb of the metal ball 14′ bounced by the sheet-shaped member 12 was measured. When the sheet-shaped member having the main dispersion C shown in FIG. 1 was mounted on the metal block 10, the bouncing height Hb of the metal ball 14′ was 0 mm.

On the other hand, when the sheet-shaped member composed of the IIR only was mounted on the metal block 10, the bouncing height Hb of the metal ball 14′ was 5 mm.

As to the main dispersion C of tan δ shown in FIG. 1, reduction rate of tan δ in a low temperature region, in which the temperature is lower than the peak temperature, is greater than that in a high temperature region, in which the temperature is higher than the peak temperature. Therefore, the vibration-damping properties of the rubber elastomer, which has the main dispersion C of tan δ shown in FIG. 1, are insufficient in the lower temperature region, in which the temperature is lower than the peak temperature.

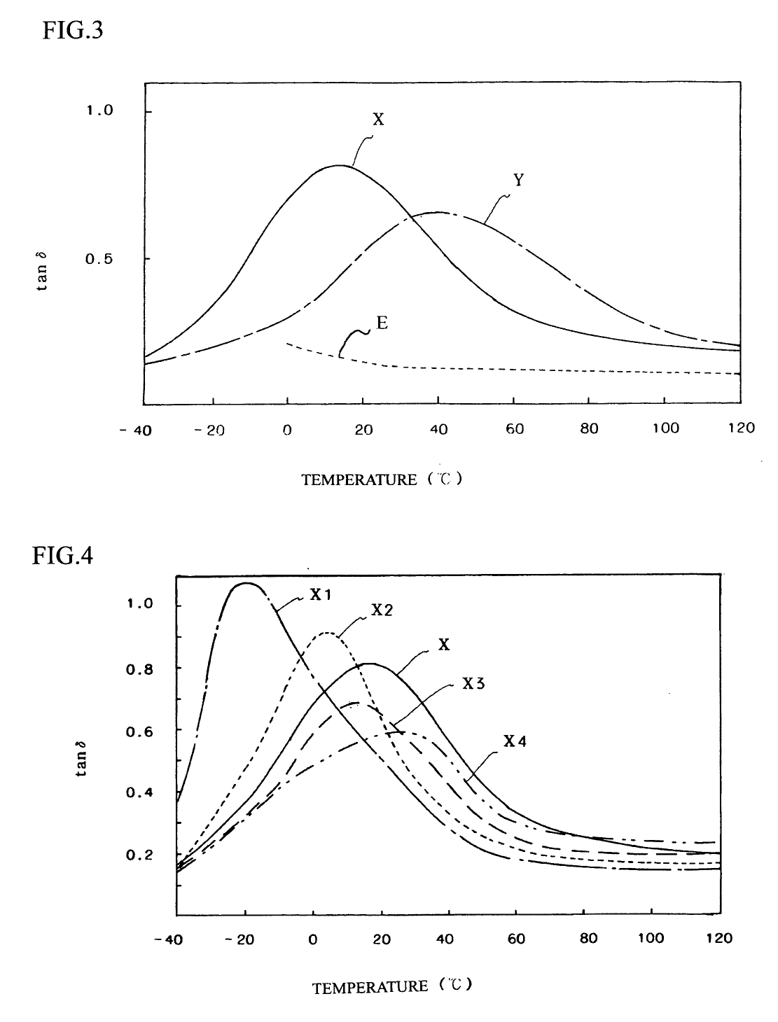

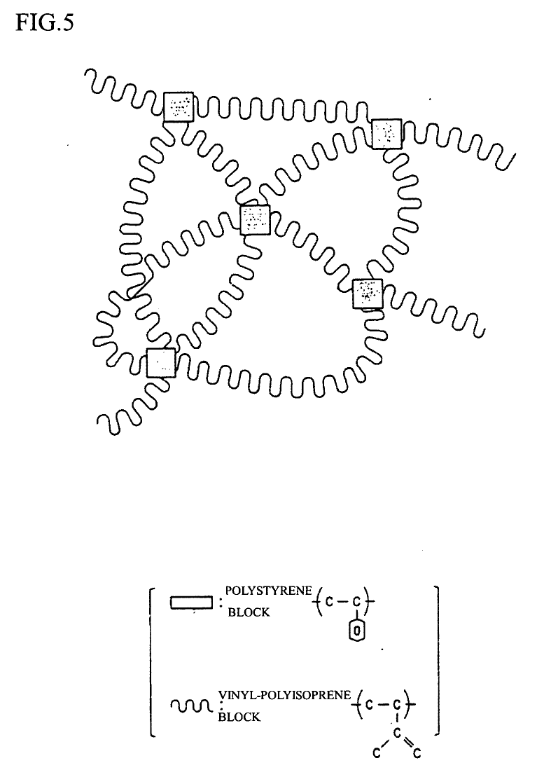

On the other hand, in rubber elastomers having main dispersions X and Y of tan δ shown in FIG. 3, the values of tan δ at temperatures of ±10° C. with respect to the peak temperature of the main dispersion of tan δ at 100 Hz are (said peak value-0.2) or greater.

The rubber elastomer having the main dispersion X of tan δ shown in FIG. 3 was produced by the steps of: kneading 100 parts by weight of ethylene-propylene copolymer (EPDM), 45 parts by weight of the block copolymer, which had the main dispersion B of tan δ shown in FIG. 6, and a crosslinking agent by a kneader; and compression-molding the mixture at a temperature of 170° C. so as to produce a sheet-shaped member having a thickness of 1 mm. The sheet-shaped member was composed of the rubber elastomer, and its hardness measured by the type A durometer was 40.

The rubber elastomer having the main dispersion Y of tan δ shown in FIG. 3 was produced by the steps of: kneading 100 parts by weight of EPDM, 45 parts by weight of the block copolymer, which had the main dispersion A of tan δ shown in FIG. 6, and a crosslinking agent by a kneader; and compression-molding the mixture at a temperature of 170° C. so as to produce a sheet-shaped member. The sheet-shaped member was also composed of the rubber elastomer, and its hardness measured by the type A durometer was 40.

Note that, main dispersion E of tan δ of a sheet-shaped member composed of EPDM only and having a thickness of 1 mm is also shown in FIG. 3.

According to FIG. 3, in the rubber elastomers having the main dispersions X and Y of tan δ shown in FIG. 3, the peak temperatures of the main dispersions of tan δ were from −20 to +60° C., the peak values were 0.4 or more, and the values of tan δ in the high temperature regions were greater than that of the main dispersion E of the sheet-shaped member composed of EPDM.

As to the main dispersion X of tan δ shown in FIG. 3, the peak value of the main dispersion of tan δ was 0.82, the peak temperature was 18° C., the value of tan δ at the temperature of “the peak temperature −10° C.” was 0.75, the value of tan δ at the temperature of “the peak temperature±10° C.” was 0.77, so the differences between the values of tan δ at the temperatures of “the peak temperature±10° C.” and the peak value were 0.07 or less.

As to the main dispersion Y of tan δ shown in FIG. 3, the peak value of the main dispersion of tan δ was 0.66, the peak temperature was 40° C., the value of tan δ at the temperature of “the peak temperature −10° C.” was 0.62, the value of tan δ at the temperature of “the peak temperature±10° C.” was 0.63, so the differences between the values of tan δ at the temperatures of “the peak temperature±10° C.” and the peak value were 0.03 or less.

On the other hand, as to the main dispersion C of tan δ shown in FIG. 1, the peak value was 1.24, the peak temperature was 20° C., the value of tan δ at the temperature of “the peak temperature −10° C.” was 0.70, the value of tan δ at the temperature of “the peak temperature±10° C.” was 0.75, so the differences between the values of tan δ at the temperatures of “the peak temperature±10° C.” and the peak value were more than 0.4.

In the main dispersions of the rubber elastomers which were produced by mixing 100 parts by weight of the EPDM with 45 parts by weight of the block copolymer and crosslinking the mixture, reduction rates of tan δ in the high temperature regions and the low temperature regions were lower than those of the block copolymer shown in FIG. 1. The inventors think that the phenomenon is caused by a web formation of the rubber elastomer, in which molecular chains of the EPDM and the block copolymer are crosslinked.

The hardness of the sheet-shaped member having the main dispersion X of tan δ shown in FIG. 3 was 40; main dispersions of tan δ of sheet-shaped members, whose hardness were changed by adjusting an amount of an inorganic additive agent, are shown in FIG. 4. In FIG. 4, the main dispersion of tan δ of the sheet-shaped member having the hardness of 10 is X1; the main dispersion of tan δ of the sheet-shaped member having the hardness of 30 is X2; the main dispersion of tan δ of the sheet-shaped member having the hardness of 50 is X3; and the main dispersion of tan δ of the sheet-shaped member having the hardness of 60 is X4.

According to FIG. 4, the peak value of the main dispersion of tan δ was reduced and the peak temperature was increased by increasing the hardness of the sheet-shaped member. The preferable hardness of the sheet-shaped member measured by the type A durometer is 80 or less.

By reducing the hardness of the sheet-shaped member, the differences between the values of tan δ at the temperatures of “the peak temperature 10° C.” and the peak value were made greater, and the value of tan δ of 25° C. at 100 Hz was made smaller, so the preferable hardness of the sheet-shaped member measured by the type A durometer is 10 or more.

In the main dispersion X1 of tan δ of the sheet-shaped member whose hardness measured by the type A durometer was 10, the peak temperature was −20° C., and the differences between the values of tan δ at the temperatures of “the peak temperature±10° C.” and the peak value were 0.2 or less.

The vibration-damping properties of the sheet-shaped member, whose main dispersion X of tan δ is shown in FIG. 3, were measured by the equipment shown in FIG. 2. In the equipment shown in FIG. 2, the sheet-shaped member having the main dispersion X of tan δ shown in FIG. 3 was mounted on the metal block 10, and the bouncing height Hb of the metal ball 14′ was 5 mm.

On the other hand, when the sheet-shaped member composed of the EDPM only was mounted on the metal block 10, the bouncing height Hb of the metal ball 14′ was 115 mm.

Further, the vibration-damping properties of the sheet-shaped member, whose main dispersion Y of tan δ is shown in FIG. 3, were measured as well, and the bouncing height Hb of the metal ball 14′ was 5 mm.

The sheet-shaped members, which respectively had the main dispersions C, X and Y of tan δ shown in FIGS. 1 and 3, had excellent vibration-damping properties, so they can be used as all-purpose vibration absorbers, e.g., a vibration absorber for a hard disk drive unit of a computer, a vibration absorber for a CD drive unit.

In comparison with the sheet-shaped member having the main dispersion X of tan δ shown in FIG. 3, the peak values of the sheet-shaped members, which respectively had the main dispersion C of tan δ shown in FIG. 1 and the main dispersion Y of tan δ shown in FIG. 3, were detected at the higher temperatures, so they can be suitably used in a relative high temperature atmosphere, e.g., vehicle.

FIG. 1 relates to the sheet-shaped members, but the vibration absorber composition of the present invention can be compression-molded, so stereoscopic products can be molded by a molding die.

### INDUSTRIAL APPLICABILITY

The vibration absorber composition of the present invention has excellent vibration-damping properties, so it can be used as all-purpose vibration absorbers, e.g., a vibration absorber for a hard disk drive unit of a computer, a vibration absorber for a CD drive unit.

The vibration absorber composition of the present invention can be compression-molded, so stereoscopic products can be molded by a molding die having a prescribed shape.

What is claimed is:

1. A vibration absorber composition being composed of a compression-moldable elastomer obtained by mixing 100 parts by weight of a rubber composition with 10-70 parts by weight of a block copolymer, which comprises a block of a styrene monomer and a vinyl-polyisoprene block and which has a main dispersion peak of tan δ at −40° C. or higher, and crosslinking the mixture,
wherein the rubber elastomer has a peak temperature for the main dispersion of tan δ at 100 Hz from −20 to +60° C., a peak value is 0.4 or greater, and
the value of tan δ of the rubber elastomer is greater than the value of tan δ at 100 Hz of the rubber composition for the main dispersion of tan δ thereof at 100 Hz in a temperature region not lower than the peak temperature.

2. The vibration absorber composition according to claim 1, wherein content of styrene in the block copolymer is 10-30%, and a glass-transition temperature thereof is −40 to +30° C.

3. The vibration absorber composition according to claim 1, wherein the value of tan δ of the rubber elastomer at 100 Hz of 25° C. is 0.3 or greater.

4. The vibration absorber composition according to claim 1, wherein hardness of the rubber elastomer measured by a type A durometer is 5-80.

5. The vibration absorber composition according to claim 1, wherein the peak temperature of the rubber elastomer for the main dispersion of tan δ at 100 Hz is from 0 to +60° C., and the value of tan δ of the rubber elastomer at 100 Hz of 60° C. is 0.2 or greater.

6. The vibration absorber composition according to claim 5, wherein the rubber composition is an isobutylene-isoprene copolymer.

7. The vibration absorber composition according to claim 1, wherein the values of tan δ at temperatures of ±10° C. with respect to the peak temperature of the main dispersion of tan δ of the rubber elastomer at 100 Hz are (said peak value−0.2) or greater.

8. The vibration absorber composition according to claim 7, wherein the rubber composition is ethylene-propylene copolymer (EPDM).
